(19) United States
(12) Patent Application Publication
(10) Pub. No.: US 2025/0337727 A1
(43) Pub. Date: Oct. 30, 2025

(54) Sending Authentication Codes for Secure Access

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US)

(73) Assignee: MICRO FOCUS LLC, WILMINGTON, DE (US)

(21) Appl. No.: 18/649,425

(22) Filed: Apr. 29, 2024

(51) Int. Cl. H04L 9/40

(52) U.S. Cl. CPC H04L 63/083; H04L 63/10

(57) ABSTRACT

Authentication codes (e.g., a One Time Passwords) are used in various ways to provide enhanced authentication. For example, multiple authentication codes may be sent to different users in order to provide access to a first user. In addition to sending authentication codes, multiple users may have to provide authentication credentials (e.g., a username/password) in order for a first user to access a resource, such as a bank account. The use of authentication codes may be applied to communication sessions, such as voice and video communication sessions. In addition, the authentication codes may be used to approve an incoming communication, such as and incoming email.

### FIELD

The disclosure relates generally to authentication systems and particularly to authentication systems that require multiple user approval for access.

### BACKGROUND

Unauthorized access to sensitive information is an ongoing problem. Even with multi-factor authentication, hackers are still gaining access to the sensitive information. What is needed are ways to provide enhanced security of the sensitive information.

### SUMMARY

These and other needs are addressed by the various embodiments and configurations of the present disclosure. The present disclosure can provide a number of advantages depending on the particular configuration. These and other advantages will be apparent from the disclosure contained herein.

In a first embodiment, a first authentication credential (e.g., a username/password) of a first user is received from a first communication device. The first authentication credential is validated. In response to validating the first authentication credential, a first authentication code (e.g., a One Time Password (OTP) is sent to the first communication device, and a second authentication code is sent. The first authentication code is received from the first communication device. The second authentication code is received. The first authentication code and the second authentication code are validated. In response validating the first authentication code and the second authentication code, access is granted to the first user to a resource.

In another embodiment, a first authentication request of a first user is received from a first communication device. The first authentication request comprises a first authentication credential. The first authentication credential is validated. In response to validating the first authentication credential, a first authentication code is to the first communication device. The first authentication code is received from the first communication device. The first authentication code received from the first communication device is validated. In response to validating the first authentication code received from the first communication device, an authentication request is sent to a second communication device of a second user requesting the second user to authenticate. A second authentication credential is received from the second user. The second authentication credential from the second user is validated. In response to validating the authentication credential from the second user, access is granted, to the first user, to a resource.

In another embodiment, a request to establish a communication session (e.g., a video conference) is received. The communication session is a communication session for a plurality of communication devices of a plurality of users. In response to receiving the request to establish the communication session, an associated authentication code is sent to each of the plurality of communication devices. A first associated authentication code is received from one of the plurality of communication devices. In response to receiving the first associated authentication code from the one of the plurality of communication devices, the one of the plurality of communication devices is added to the communication session.

In another embodiment, an incoming communication request from a first user to a second user is received. A determination is made if the incoming communication request from the first user is from a new user. In response to determining that the incoming communication request is from the new user, a first authentication code is sent to the second user. The process waits to receive the first authentication code from the second user. In response to receiving the first authentication code from the second user, the incoming communication request is allowed. In response to not receiving the first authentication code from the second user, the incoming communication request is not allowed.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficulty level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

As defined herein, the term “authentication code” may be any type of authentication code, such as an authentication code in SMS message, an authentication code in an email, an authentication code in a chat, an authentication code as a One-Time-Password (OTP), and/or the like. When describing authentication codes herein, the types of authentication codes being used may be different in different steps. For example, a first authentication code in a first step sent to a first user may be one type (e.g., in a SMS message) and a second authentication code in a second step sent to a second user may be a different type (e.g., in an OTP). The different authentication codes described in different steps may have the same or different values. For example, a first authentication code may have a value of 12345679 and a second authentication code may have a value of 33445566. Alternatively, the first and second authentication codes may have a same value (e.g., 123456789).

As described herein, the term “resource” may be any type of resource, such as, a bank account, a database, a file system, a network, a building, an embedded device, a software application, a website, a social media site, and/or the like.

As described herein, a communications requests can be any type of communication request, such as, an email, a chat, a SMS message, a social media invite, a voice call, a video call, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for sending authentication codes for secure access.

FIG. 2 is a flow diagram of a process for sending authentication codes to multiple communication devices of different users for secure access.

FIG. 3 is a flow diagram of a process for sending authentication codes to multiple communication devices of different users for secure access.

FIG. 4 is a flow diagram of a process for sending authentication codes to multiple communication devices of different users but receiving the authentication codes from the same communication device.

FIG. 5 is a flow diagram of a process for sending authentication codes to multiple communication devices of the same user.

FIG. 6 is a flow diagram of a process for sending authentication codes to multiple users with different approval levels.

FIG. 7 is a flow diagram of a process for sending a second authentication request to a second user to allow access for a first user.

FIG. 8 is a flow diagram of a process sending authentication codes to users in order to access a communication session.

FIG. 9 is a flow diagram of a process for sending an authentication code to allow an incoming communication.

FIG. 10 is a flow diagram of a process for sending an authentication code to view a portion of an incoming communication and requiring an authentication credential to view the full incoming communication.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

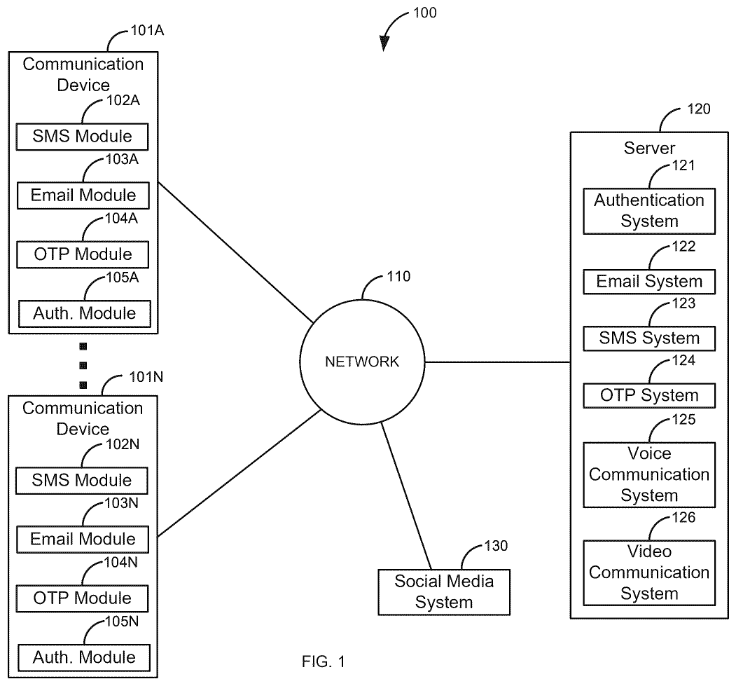

FIG. 1 is a block diagram of a first illustrative system 100 for sending authentication codes for secure access. The first illustrative system 100 comprises communication devices 101A-101N, a network 110, a server 120, and a social media system 130.

The communication devices 101A-101N can be or may include any user device that can communicate on the network 110, such as a Personal Computer (PC), a telephone, a video system, a cellular telephone, a Personal Digital Assistant (PDA), a tablet device, a notebook device, a laptop computer, a smartphone, and/or the like. As shown in FIG. 1, any number of communication devices 101A-101N may be connected to the network 110, including only a single communication device 101. The communication devices 101A-101N further comprises Short Message Service (SMS) modules 102A-102N, email modules 103A-103N, One-Time Password (OTP) modules 104A-104N, and Authentication modules 105A-105N.

The SMS modules 102A-102N can be or may include any software coupled with hardware that can send and receive SMS messages from the server 120. The SMS modules 102A-102N allow a user to receive an SMS code and the provide the SMS code to the authentication system 121. The SMS modules 102A-102N may work locally or via a browser. The SMS modules 102A-102N work in conjunction with the authentication system 121.

The email modules 103A-103N may be any software coupled with hardware that can provide email services to the communication devices 101A-101N. The email modules 103A-103N may reside on the communication devices 101A-101N or may be downloaded via a browser. The email modules 103A-103N work in conjunction with the authentication system 121. The email modules 103A-103N may receive authentication codes in an email.

The OTP modules 104A-104N may be any software coupled with hardware that can provide one-time passwords. The OTP modules 104A-104N receive one-time passwords from the OTP system 124 and then, based on approval, send the one-time passwords back to the OTP system 124. The OTP modules 104A-104N work in conjunction with the authentication system 121. In one embodiment, the OTP modules 104A-104N may receive an authentication code and encrypt the authentication code when sending the authentication code back to the authentication system 121 using a encryption key.

The authentication modules 105A-105N may be any software coupled with hardware that can provide authentication services to a user. The authentication modules 105A-105N may be stored locally on the communication devices 101A-101N and/or may be downloaded via a browser. The authentication modules 105A-105N work in conjunction with the authentication system 121. The authentication modules may support various types of authentication, such as usernames/passwords, fingerprint scans, iris scans, palm prints, voice prints, and/or the like.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The server 120 can be or may include any device that can provide authentication services, such as a communications server, an authentication service, a single sign-on system, a cloud service, and/or the like. The server 102 further comprises an authentication system 121, an email system 122, an SMS system 123, an OTP system 124, a voice communication system 125, and a video communication system 126.

The authentication system 121 can be or may include any software coupled with hardware that can provide authentication services for users. The authentication system 121 may use various types of authentications, such as, usernames/passwords, fingerprint scans, iris scans, facial scans, voiceprints, SMS messages, OTPs, email codes, security questions, chat codes, and/or the like. The authentication system 121 may provide single factor authentication, multi-factor authentication, single sign-on authentication, and/or the like. The authentication system 121 may work in conjunction with the authentication modules 105A-105N.

The email system 122 can be or may include any system that can provide email services, such as Microsoft Outlook®, Google mail®, Opentext's Groupwise®, and/or the like. The email system 122 may work in conjunction with the email modules 103A-103N. The email system 122 may work in conjunction with the authentication system 121.

The SMS system 123 can be or may include any system that can provide SMS services. The SMS system 123 sends and then validates SMS codes sent to the communication devices 101A-101N. The SMS system 123 may work in conjunction with the SMS modules 102A-102N. The SMS system 123 may work in conjunction with the authentication system 121.

The OTP system 124 can be or may include any system that can be used to send and validate OTPs. The OTP system 124 may work with the OPT modules 104A-104N. The OTP system 124 may work in conjunction with the authentication system 121.

The voice communication system 125 can be or may include any software coupled with hardware that can provide voice communications, such as a Private Brach Exchange, a central office switch, a cellular communications system. The voice communication system 125 may use a voice mixer to provide voice communication services. The voice communication system 125 may work in conjunction with a voice module (not shown) on a communication device 101. The voice communication system 125 may also comprise a voicemail system.

The video communication system 126 can be or may include any software coupled with software that can provide video communication services, such as a video conferencing system, a video mixer, and/or the like. The video communication system 126 may work in conjunction with a video module (not shown) on a communication device 101. The video system 126 may also comprise a videomail system.

The social media system 130 may be any type of social media site. The social media system 130 may provide users with the ability to communicate with each other via the social media system 130. In one embodiment, the social media system 130 may reside on the server 120.

Although not shown the server 120 may provide other services, such as chat services and/or the like.

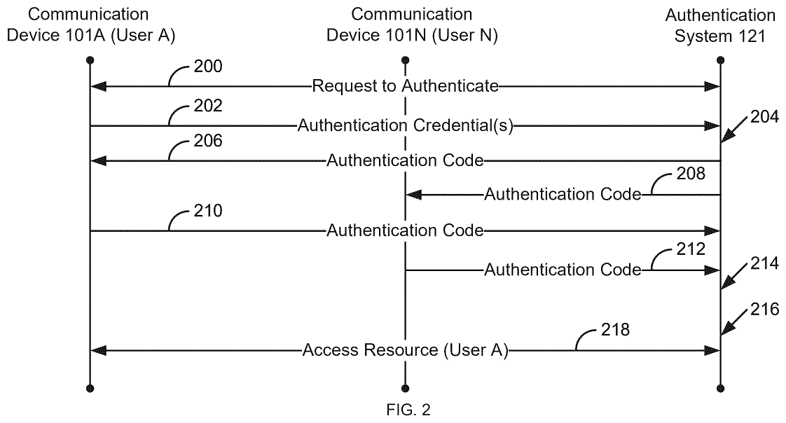

FIG. 2 is a flow diagram of a process for sending authentication codes to multiple communication devices 101A/101N of different users for secure access. Illustratively, the communication devices 101A-101N, the SMS modules 102A-102N, the email modules 103A-103N, the OTP modules 104A-104N, the authentication modules 105A-105N, the server 120, the authentication system 121, the email system 122, the SMS system 123, the OTP system 124, the voice communication system 125, the video communication system 126, and the social media system 130 are stored-program-controlled entities, such as a computer or microprocessor, which performs the method of FIGS. 2-10 and the processes described herein by executing program instructions stored in a computer readable storage medium, such as a memory (i.e., a computer memory, a hard disk, and/or the like). Although the methods described in FIGS. 2-10 are shown in a specific order, one of skill in the art would recognize that the steps in FIGS. 2-10 may be implemented in different orders and/or be implemented in a multi-threaded environment. Moreover, various steps may be omitted or added based on implementation.

A user (user A), from the communication device 101A requests to authenticate at the authentication system 121 in step 200. For example, the first user may want to access a bank account that has two users (e.g., a husband and wife). The user A provides one or more authentication credentials (e.g., a username/password) to the authentication system 121 in step 202. The authentication system 121 validates that the authentication credential(s) are valid in step 204.

If the authentication credential(s) are valid in step 204, the authentication system 121 sends, in step 206, a first authentication code to the communication device 101A (user A). The authentication system 121 sends, in step 208, a second authentication code to the communication device 101N (user N).

The user A, via the communication device 101A, responds by causing the first the first authentication code to be sent back to the authentication system 121 in step 210. The user N, via the communication device 101N, responds, by causing the second authentication code to be sent back to the authentication system 121 in step 212. The authentication system 121 validates that the first and second authentication codes are correct in step 214. In response to the first and second authentication codes being correct in step 214, the authentication system 121 grants access to the resource in step 216. The user A can then access the resource in step 218. In the example of FIG. 2, there are three different authentication factors required in order to access the account: two from the user A and one from the user N.

The process of FIG. 2 may be account/access based. For example, if there are three members of the account, the other two members may have to provide an authentication code to allow the third member to get access to the account. The number of required authentication codes may be based on predefined and/or administered rules. For example, assuming that there are four account members, in one embodiment, two out of the three remaining members of the account may have to approve by sending authentication codes in order for one user to access the account.

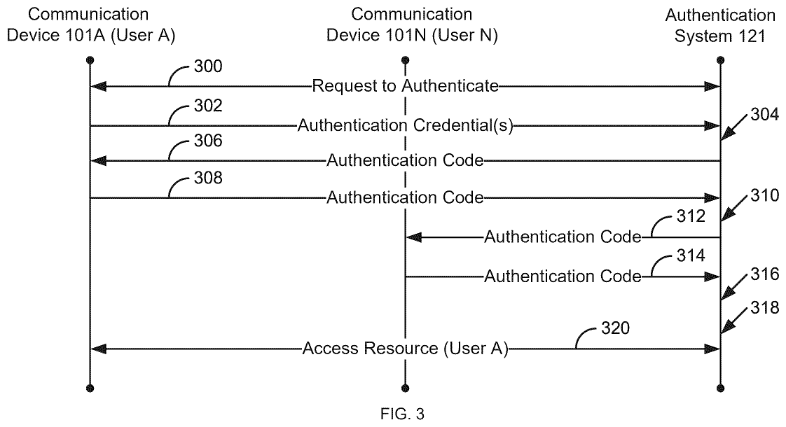

FIG. 3 is a flow diagram of a process for sending authentication codes to multiple communication devices 101A/101N of different users for secure access. A user (user A), from the communication device 101A requests to authenticate at the authentication system 121 in step 300. For example, the user A may want to access a database on the network 110. The user A provides one or more authentication credentials (e.g., a username/password and a fingerprint scan) to the authentication system 121 in step 302. The authentication system 121 validates that the authentication credential(s) are valid in step 304.

If the authentication credential(s) are valid in step 304, the authentication system 121 sends, in step 306, a first authentication code to the communication device 101A (user A). The user A causes the authentication code to be sent, via the communication device 101A, to the authentication system 121 in step 308. The authentication system 121 validates that the first authentication code is correct in step 310.

If the first authentication code is valid in step 310, the authentication system 121 sends in step 312, the second authentication code to the communication device 101N of the user N. The second authentication code may include additional information, such as, a message indicating that the user A has authenticated and sent an authentication code along with a time/date stamp of when the authentication code was sent. The user N causes the second authentication code to be sent, via the communication device 101N to the authentication system 121 in step 314. For example, the user N may click on a button in an email that causes the second authentication code to be sent in step 314. The authentication system 121 confirms that the second authentication code is valid in step 316. In response to the second authentication code being valid in step 316, the authentication system 121 grants access to the resource in step 318 (e.g., the database on the network 110). The user A can then access the resource in step 320.

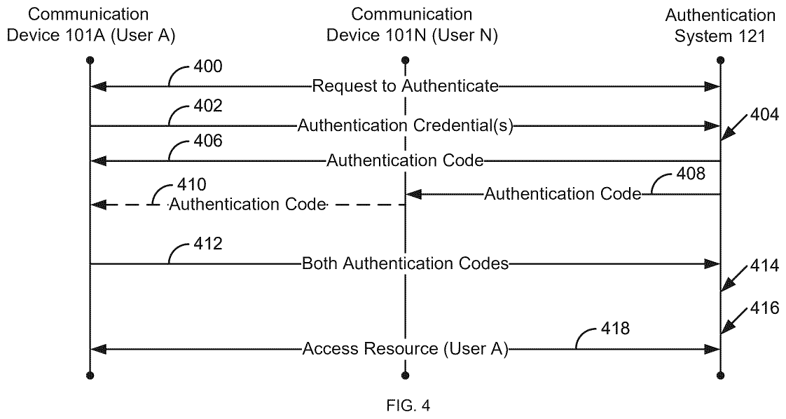

FIG. 4 is a flow diagram of a process for sending authentication codes to multiple communication devices 101A/101N of different users but receiving the authentication codes from the same communication device 101A. A user (user A), from the communication device 101A requests to authenticate at the authentication system 121 in step 400. For example, the first user may want to access a secure printing device. The user provides one or more authentication credentials (e.g., an iris scan) to the authentication system 121 in step 402. The authentication system 121 validates that the authentication credential(s) are valid in step 404.

If the authentication credential(s) are valid in step 404, the authentication service 121 sends, in step 406, a first authentication code to the communication device 101A (user A). The authentication service 121 sends, in step 408, a second authentication code to the communication device 101N (user N).

The user A gets the second authentication code from the user N. For example, the user N may forward the second authentication code to the user A in step 410, or the user N may give the second authentication code to the user A verbally (e.g., in person or via a phone call). The user A, via the communication device 101A, responds by causing the both the first and second authentication codes to be sent, via the communication device 101A to the authentication system 121 in step 412.

In response to the first and second authentication codes being correct in step 414, the authentication system 121 grants access to the resource in step 416. The user A can then access the resource (e.g., the secure printing device) in step 418.

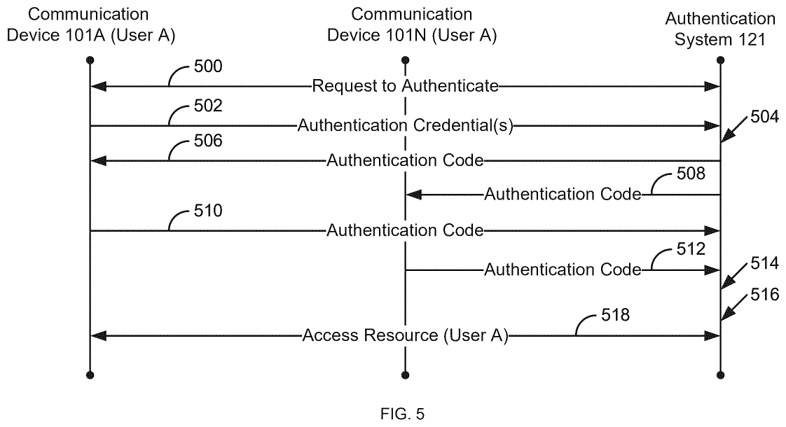

FIG. 5 is a flow diagram of a process for sending authentication codes to multiple communication devices 101A/101N of the same user. A user (user A), from the communication device 101A requests to authenticate at the authentication system 121 in step 500. For example, the first user may want to access a specific website. The user A provides one or more authentication credentials (e.g., a username/password and a voiceprint) to the authentication system 121 in step 502. The authentication system 121 validates that the authentication credential(s) are correct in step 504.

If the authentication credential(s) are valid in step 504, the authentication system 121 sends, in step 506, a first authentication code to the communication device 101A (e.g., the authentication code in an email that is sent a personal computer of user A). The authentication system 121 sends, in step 508, a second authentication code to the communication device 101N (e.g., a SMS authentication code to a smartphone of the user A).

The user A, via the communication device 101A, responds by causing the first the first authentication code to be sent back to the authentication system 121 in step 510. The user A, via the communication device 101N, responds, by causing the second authentication code to be sent to the authentication system 121 in step 512. The authentication system 121 validates that the first and second authentication codes are correct in step 514. In response to the first and second authentication codes being correct in step 514, the authentication system 121 grants access to the resource in step 516. The user A can then access the resource in step 518.

Another option for FIG. 5 is where the user A requires both authentication codes (the authentication codes sent in steps 510 and 512) to access the resource. However, the second user N only needs to provide their username/password and provide single authentication code sent to their phone to access the account. For example, the N user is a parent, and the user A is a child.

Another option to FIG. 5 is to use authentication credentials from the communication device 101N instead of the second authentication code in steps 508/512. The second set of authentication credential(s) of the user N may be a second different password. In addition, the system could also validate that there are two different authentications from two different devices (e.g., with two different IP addresses or device tokens).

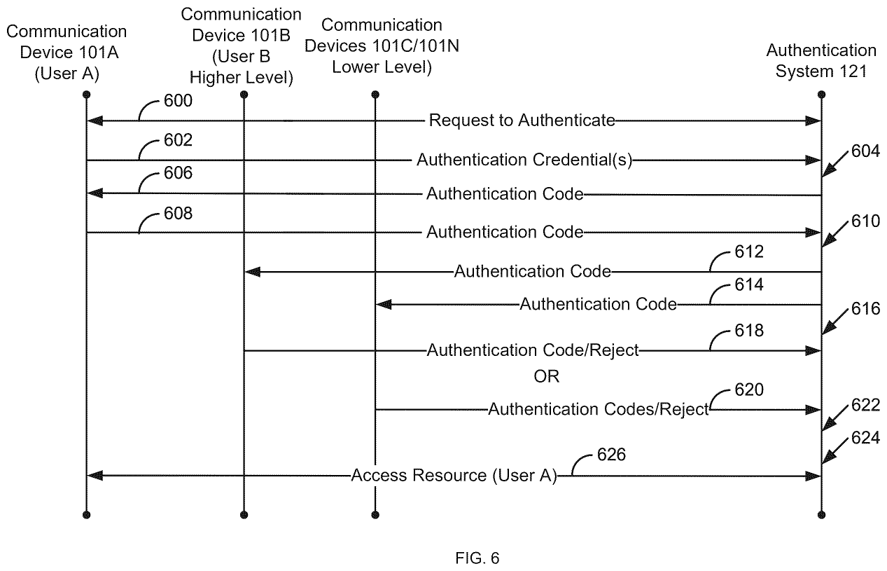

FIG. 6 is a flow diagram of a process for sending authentication codes to multiple users with different approval levels. A user (user A), from the communication device 101A requests to authenticate at the authentication system 121 in step 600. For example, the first user may want to access a corporate bank account. The user A provides one or more authentication credentials (e.g., a username/password) to the authentication system 121 in step 602. The authentication system 121 validates that the authentication credential(s) are correct in step 604.

If the authentication credential(s) are valid in step 604, the authentication system 121 sends, in step 606, a first authentication code to the communication device 101A (user A). The user A, via the communication device 101A, responds by causing the first the first authentication code to be sent back to the authentication system 121 in step 608. The authentication system 121 validates that the first authentication code is valid in step 610.

In response to the first authentication code being valid in step 610, the authentication system 121 sends, in step 612, an authentication code to the communication device 101B (user B). The authentication system 121 sends authentication codes to the communication devices 101C/101N in step 614. The authentication system 121 waits, in step 616, to receive one of the authentication code sent to the communication device 101B or the authentication codes sent to the communication devices 101C/101N.

If the authentication code of step 612 is received in step 618 or the authentication codes sent in step 614 are received in step 620, the authentication service 121 validates that the authentication codes received in steps 618 and/or 620 are correct in step 622. In response to either the authentication code received in steps 618 and/or the authentication codes received in step 620, the authentication system 121 grants access to the resource in step 624. The user A can then access the resource in step 626. If the user B responds before the users C and N, the users C/N may be notified. Likewise, if the users C and N respond before the user B, the user B may be notified.

In FIG. 6, the second user B may reject the access to the account and/or the users C/N could collectively reject the access to the account. In addition, the user B may have the option to override the rejection of the users C/N. In this example, a message may be sent to the user B to approve the rejection by the users C/N. The user B may have the option to just let the rejection by the users C and N stand by not responding. Instead of using authentication codes in steps 612-620, the users B, C, and N may have to login and provide authentication credentials instead of authentication codes.

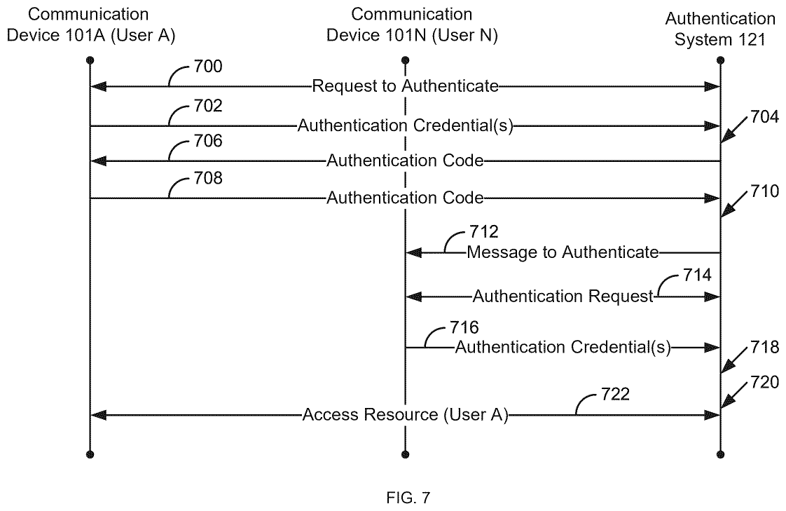

FIG. 7 is a flow diagram of a process for sending a second authentication request to a second user to allow access for a first user. A user (user A), from the communication device 101A requests to authenticate at the authentication system 121 in step 700. For example, the user A may want to access a software application on the server 120. The user A provides one or more authentication credentials (e.g., a username/password and a palm print) to the authentication system 121 in step 702. The authentication system 121 validates that the authentication credential(s) are valid in step 704.

If the authentication credential(s) are valid in step 704, the authentication system 121 sends, in step 706, a first authentication code to the communication device 101A (user A). The user A causes the authentication code to be sent, via the communication device 101A, to the authentication system 121 in step 708. The authentication system 121 validates that the first authentication code is correct in step 710.

If the first authentication code is correct in step 710, the authentication system 121 sends in step 712, a message (e.g., an SMS message) to the communication device 101N of the user N requesting the user N to authenticate. The user N then requests to authenticate in step 714. The user N the provides the authentication credential(s) in step 716 (e.g., a username/password). The authentication system 121 validates, in step 718, the authentication credentials provided in step 716. In response to the authentication credential(s) being valid in step 718, the authentication system 121 grants access to the resource in step 720 (e.g., the software application on the server 120). The user A can then access the resource in step 722.

With the process described in FIG. 7, where the user N is also authenticated at the same time as the user A, the user N could concurrently view/approve any transactions of the user A. For example, assuming the resource is a bank account of the user A, if the user A (e.g., a child) wanted to withdraw $1,000 dollars from the bank account, the user N (a parent) may have the option to approve the transaction. This may include having an amount/number of transactions (e.g., over a time period) threshold. For example, any transaction over $50 dollars would require the approval of the user N. The sending of the message in step 712 may be based on a transaction amount after the user A has logged in. For example, if the user A wants to withdraw an amount over $100, the second user would receive the message of step 712 and then be required to login to approve the transaction over $100.

In addition to providing an authentication credential in step 716, the approval process may also include sending an authentication code and receiving an authentication code from the user N in order to approve a specific transaction. For example, the user N would receive an authentication code to approve the transaction over $100. The user would then send the authentication to the authentication system 121 in to approve the transaction.

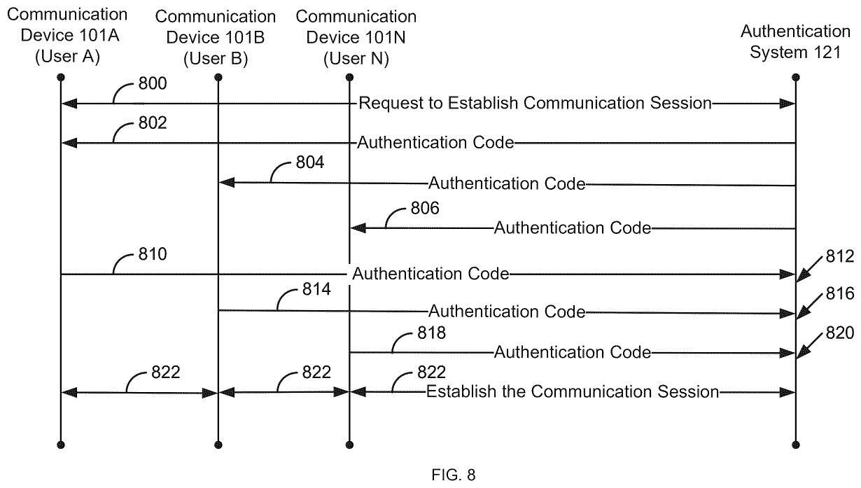

FIG. 8 is a flow diagram of a process sending authentication codes to users in order to access a communication session. The communication session may be a voice communication session, a video communication session, an email communication session, a SMS communication session, a chat communication session, and/or the like. FIG. 8 is described where the communication session comprises three users: user A, user B, and user N.

The process starts in step 800 where a request to establish a communication session is received. In step 800, the request to establish the communication session may come from the communication device 101A. For example, the user A could create a communication session request using a roster of the users in the communication session. Alternatively, the request may be generated on the server 120. For example, a calendaring system on the server 120 may have meeting scheduled at a specific time that includes the users A, B, and N.

In response to receiving the request to establish the communication session in step 800, authentication codes (for each user in the communication session) are set to the communication devices 101A, 101B, and 101N in steps 802, 804, and 806. The user A, via the communication 101A causes the first authentication code to be sent to the authentication system 121 in step 810. The authentication system 121 determines, in step 812, if the first authentication code is correct. The user B, via the communication 101B causes the second authentication code to be sent to the authentication system 121 in step 814. The authentication system 121 determines, in step 816, if the second authentication code is correct. The user N, via the communication 101N causes the third authentication code to be sent to the authentication system 121 in step 818. The authentication system 121 determines, in step 820, if the third authentication code is correct.

If all three of the authentication codes are correct in steps 812, 816, and 820, the communication session is established, in step 822, between the communication devices 101A, 101B, and 101N. In one embodiment, the communication session may be established after step 812 where the user A is added to the communication session. Likewise, in step 816, the user B will be added to the communication session and so on for each user in the communication session.

The process of FIG. 8 may also be tied to an authentication process (e.g., a username/password for each user). For example, in order to establish/access a voice or video communication session, just before the meeting starts, an SMS message with an authentication code is sent along with a request to have each user login in the communion session. Each user would have to login and provide the authentication code in order to join the communication session.

While waiting (e.g., in a waiting area until all users have provided authentication codes and/or authentication credential(s)), the system could say (or display if a video call) that 3 out of 5 users have logged in and have provide their authentication code (saying or showing those who have and have not). The displayed/voice message may be provided only to those that have provided the necessary authentication code and/or authentication credential(s) or to all users who can join the communication session. In one embodiment, if all users are required to start the communication session, an individual user may respond to the authentication code with an option to start the communication session without the user actually joining the communication session. Thus, the communication session can start even though the user is not going to join the communication session.

Access to the communication session may use location information. For example, assume that a video communication session is between three users. The first two users are inside a secure network 110 and the third user is outside the secure network 110 or from another company. In this example, the first two users will each receive an authentication code while the third user could receive an authentication code and be asked to provide a username/password in order to access/start the video communication session.

In one embodiment, the authentication code is a start communication session authentication code. The start communication session authentication code may be sent to a meeting organizer. For example, the authentication code could have a header that identifies it as a start communication session code and a separate unique code for the user. A user who is not a meeting organizer would have a different code in the header. In this example, there could be multiple users who have a start communication session code. Alternatively, the user can append the start communication session code to the sent code. The users may be in different companies/organizations. In this example, the users of the primary company/organization who called the meeting may each have a start communication session authentication code and the ones from the other company/organization will not. The start communication session code may be a random number for each communication session and may also be encrypted.

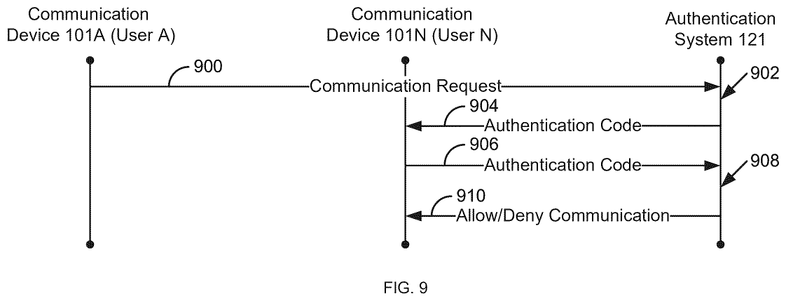

FIG. 9 is a flow diagram of a process for sending an authentication code to allow an incoming communication. For inbound communications requests (e.g., emails, chats, SMS messages, social media invites (e.g., from the social media system 130), voice calls, video calls, etc.), FIG. 9 shows an exemplary embodiment for using authentication codes. The user A, from the communication device 101A sends a communication request (e.g., an email, a chat request, a SMS message, a social media invite, etc.) in step 900. The authentication system 121 identifies, in step 902, if the user A is a new user. A new user is a user who is sending the communication request (e.g., email) for the first time to the user N. The communication request may be any type of communication request from the first user or a specific type of communication request (e.g., an email request versus a voice communication session request).

If the user A is a new user in step 902, the authentication system 121 sends, in step 904, an authentication code to the communication device 101N in step 904. The user N, via the communication device 101N, cause the authentication code to be sent back to the authentication system 121 in step 906. Alternatively, the user N could reject the communication request in step 906. The authentication system 121 determines, if the authentication code is correct or if the user N has rejected the communication request of step 900 in step 908.

If the authentication code is correct in step 908, the communication request is allowed in step 910. Otherwise, the communication request is denied in step 908. How the denial is handled may be accomplished in various ways, such as blocking a sender of the communication request (in that specific type (e.g., email), a select number of types, or all types), sending an email to a junk mail folder, filtering out the email, filtering out a SMS message, not establishing the video communication session, not establishing the audio communication session, blocking a chat, blocking a social media invite, sending an audio communication session to voicemail, and sending a video communication session to videomail, and/or the like.

In another embodiment, if an email/chat/SMS message is sent from user A to a user N, the user N may have to provide a username/password and/or SMS code in order for the email/chat/SMS message to be received by the user N. For example, the email may be a secure email that has to be validated that the second user received the secure email.

Another option of allowing the communication request may be to unencrypt the email/chat/SMS message based on step 908 based on a digital certificate in the communication request. In addition, the user N may have to provide an authentication credential(s) (e.g., a username/password).

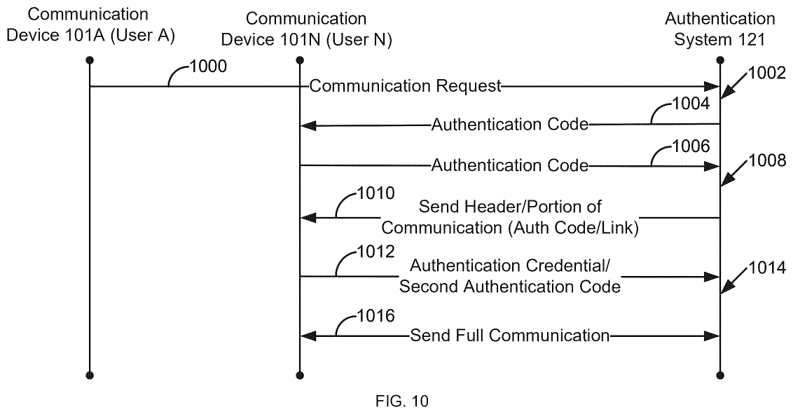

FIG. 10 is a flow diagram of a process for sending an authentication code to view a portion of an incoming communication and requiring an authentication credential to view the full incoming communication. The user A, via the communication device 101A, sends a communication request to the authentication system 121 in step 1000. For example, the communication request may be an email. The authentication system 121 determines, in step 1002, if the user A is a new user. If the user A is a not a new user, the communication request may proceed as normal. Optionally the process may continue even though the user A is not a new user.

Otherwise, if the user A is a new user in step 1002, the authentication system 121 sends, in step 1004, an authentication code to the communication device 101N. The user N responds by causing the communication device 101N to send the authentication code in step 1006. If the user wants to deny the communication request in step 1006, the user may have an option that denies the request and does not send the authentication code. The authentication system 121 determines, in step 1008, if the authentication code is valid. If the authentication code is not valid in step 1008, the process ends (or the communication request is rejected).

Otherwise, if the authentication code is correct in step 1008, a header or portion of the communication request is sent to the communication device 101N in step 1010. For example, if the communication request is an email, the header may be the header of the email. If the communication request is for a voicemail, the portion may be the first couple sentences of the voicemail or a portion of the translated text of the voicemail. If the communication request for a videomail, the portion may be the first twenty seconds of the videomail or a portion of text of the first portion of the voicemail.

The message of step 1010 may also have a link that allows the user to authenticate using an authentication credential(s). Alternatively, the message of step 1010 may have a second authentication code. The user N then authenticates/provides the second authentication code in step 1012. The authentication system 121 the validates the authentication code/authentication credential(s) in step 1014. If the authentication code/authentication credential(s) are valid in step 1014, the full communication is sent (or access is allowed) in step 1016. For example, the user N will now be able to access the email or voicemail in step 1016.

All the processes described herein may be based on a time-of-day. For example, if the user A is trying to login after working hours, the process of sending authentication codes to the user A and the user N may be required. Whereas if the user A is logging in during work hours, the user A may be only be required to provide a username/password and send an authentication code to login with no approval from the user N. However, if the first user tries to login outside of normal working hours, the authentication code from the user N may be required.

In addition, the processes described herein may be tied to location information. For example, if the user A is logging in from home versus a mobile device in a non-normal location, an additional authentication processes may be required. If the user A is logging in from a new location (e.g., in Russia), the user A will have to provide the authentication code they received and the authentication code of their supervisor. The location information could be tied in with the time-of-day information. For example, if the user A is trying to login from a new location that is outside normal working hours, an authentication code may be sent to the users B and N where both have to approve before the user A can be authenticated. This could also apply to the supervisor. For example, if the supervisor location is now in Russia, another user may have to approve the transaction.

The processes above could be extended to where a user clicks on a link to a secure site/single sign-on process. Once the user A clicks on the link, any of the above processes could be used. For example, if the user A clicks on a link to a secure website, before accessing the website, the user A will be redirected to the authentication system 121. The user A then provides their username/password and then sends the received authentication code along with an authentication code the user A got from user N. Once authenticated, the user A gets redirected to the website associated with the link.

For all the processes above where there are different approvers, the information for each level/type of approver may be stored in a different database. For example, if the first user's username/password were hacked in a first database, the hacker would still not have access to the second user's information (e.g., their phone number, email address, username/password, etc.). Thus, the separation of the authentication information for the different users in different locations makes the overall authentication process more secure.

The authentication codes may have an associated time-out value. For example, an SMS authentication code may have a ten-minute time-out value. If the authentication codes(s) have expired, the user A will have to start the process over again in order to authenticate.

All of the above process could be tracked via a blockchain. For example, using the above secure email process, the blockchain could show that the second user signed in with a username/password and provided an SMS authentication code as verification of receiving the secure email. The blockchain may have the time/date of when the user logged in and provided the SMS authentication code.

All the above processes could be administered by the user or by an administrator. In addition, the processes could be administered at various levels, such as at a document level, at a section level (e.g., for accessing a specific section in a document, accessing a specific field in a database, accessing a specific field, row, column in a spread sheet, at a device level (e.g., accessing a database server, accessing a printer, and/or the like), at a network level, at a record level, at a physical location level (e.g., accessing a room), and/or the like). For example, in order for a user A to access a building, a first OTP authentication code may be required from the user N to access a building. If the user A tries to access a specific room in the building, a second OPT authentication code may be required from another user (or both users).

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
receive a first authentication credential of a first user from a first communication device;
validate the first authentication credential;
in response to validating the first authentication credential, send a first authentication code to the first communication device of the first user, and send a second authentication code;
receive the first authentication code from the first communication device of the first user;
receive the second authentication code;
validate the first authentication code and the second authentication code; and
in response validating the first authentication code and the second authentication code, grant access, to the first user, to a resource.

2. The system of claim 1, wherein the second authentication code is sent to a second communication device of a second user, wherein the second authentication code is received from the second communication device of the second user, and wherein the second authentication code is sent to the second communication device before the first authentication code is received from the first communication device.

3. The system of claim 1, wherein the second authentication code is sent to a second communication device of a second user, wherein the second authentication code is received from the second communication device of the second user, and wherein the second authentication code is sent to the second communication device after receiving the first authentication code from the first communication device.

4. The system of claim 1, wherein the second authentication code is sent to a second communication device of a second user and wherein the second authentication code is received from the first communication device of the first user.

5. The system of claim 1, wherein the second authentication code is sent to a second communication device of the first user, wherein the second authentication code is received from the second communication device of the first user.

6. The system of claim 1, wherein the second communication device comprises a plurality of communication devices of a plurality of users and wherein the second authentication code is received from one of the plurality of communication devices of the plurality of users.

7. The system of claim 1, wherein the second communication device comprises a plurality of communication devices of a plurality of users, wherein the second authentication code comprises a plurality of second authentication codes that are different, wherein the plurality of users comprises a second user at a first higher level and at least two users at a second lower level, and wherein receiving a first second authentication code from the second user at the higher level grants access to the resource or receiving two different second authentication codes from the at least two users at the second level grants access to the resource.

8. The system of claim 1, wherein the second communication device comprises a plurality of communication devices of a plurality of users, wherein the second authentication code comprises a plurality of second codes that are different, wherein the plurality of users comprises a second user at a first higher level and at least two users at a second lower level, and wherein the first user at the first higher level can reject granting the access to the resource and the at least two users at the second level in combination can reject granting access to the resource.

9. A system comprising:
a microprocessor; and
a computer readable medium, coupled with the microprocessor and comprising microprocessor readable and executable instructions that, when executed by the microprocessor, cause the microprocessor to:
receive a first authentication request of a first user from a first communication device, wherein the first authentication request comprises a first authentication credential;
validate the first authentication credential;
in response to validating the first authentication credential, send a first authentication code to the first communication device;
receive, from the first communication device, the first authentication code;
validate the first authentication code received from the first communication device;
in response to validating the first authentication code received from the first communication device, send an authentication request to a second communication device of a second user requesting the second user to authenticate;
receive a second authentication credential from the second user;
validate the second authentication credential from the second user; and
in response to validating the authentication credential from the second user, granting access, to the first user, to a resource.

10. The system of claim 9, wherein the second user can do at least one of:
view a transaction of the first user;
approve a transaction of the first user;
approve a transaction that is over a number of transactions in at time period; and
approve a transaction of the first user over a specified amount.

11. The system of claim 10, wherein the second user approves the transaction of the first user, or the transaction of the first user over the specified amount, and
wherein the microprocessor readable and executable instructions further cause the microprocessor to:
send a second authentication code to the second communication device;
receive the second authentication code from the second communication device;
validate the second authentication code; and
in response to validating the second authentication code, approve the transaction of the first user, or approve the transaction of the first user over the specified amount.

12. A system comprising:
a microprocessor; and
a computer readable medium, coupled with the microprocessor and comprising microprocessor readable and executable instructions that, when executed by the microprocessor, cause the microprocessor to:
receive a request to establish a communication session, wherein the communication session is a communication session for a plurality of communication devices of a plurality of users;
in response to receiving the request to establish the communication session, send an associated authentication code to each of the plurality of communication devices of the plurality of users;
receive a first associated authentication code from one of the plurality of communication devices of the plurality of users; and
in response to receiving the first associated authentication code from the one of the plurality of communication devices of the plurality of users, adding the one of the plurality of communication devices of the plurality of users to the communication session.

13. The system of claim 12, wherein adding the one of the plurality of communication devices to the communication session occurs when all the associated authentication codes from each of the plurality of communication devices of the plurality of users have been received and validated.

14. The system of claim 12, wherein adding the one of the plurality of communication devices to the communication session comprises adding the one of the plurality of communication devices in a waiting area, and wherein the one of the plurality of communication devices displays or plays a number of users who have provided their associated authentication codes for establishing the communication session.

15. The system of claim 12, wherein the first authentication code from the one of the plurality of communication devices comprises a start communication session authentication code that establishes the communication session.

16. The system of claim 15, wherein the first authentication code comprises a first field that has the start communication session authentication code and a second field that has a unique authentication code.

17. The system of claim 15, wherein the start communication session authentication code is a different value for each communication session and the start communication session authentication code is sent to one or more of the plurality of communication devices of the plurality of users.

18. A system comprising:
a microprocessor; and
a computer readable medium, coupled with the microprocessor and comprising microprocessor readable and executable instructions that, when executed by the microprocessor, cause the microprocessor to:
receive an incoming communication request from a first user to a second user;
determine if the incoming communication request from the first user to the second user is from a new user;
in response to determining that the incoming communication request is from the new user, send a first authentication code to the second user;
wait to receive the first authentication code from the second user;
in response to receiving the first authentication code from the second user, allow the incoming communication request; and
in response to not receiving the first authentication code from the second user, not allowing the incoming communication request.

19. The system of claim 18, wherein the incoming communication request is one of: an email communication request, a Short Message Service (SMS) communication request, a video communication request, an audio communication request, a chat communication request, and a social media invite request.

20. The system of claim 18, wherein not allowing the incoming communication request comprises one or more of: blocking the first user, sending an email to a junk mail folder, filtering out the email, filtering out a SMS message, not establishing a video communication session, not establishing an audio communication session, blocking a chat, blocking the social media invite request, sending the audio communication request to voicemail, and sending a video communication request to videomail.

21. The system of claim 18, wherein the incoming communication session is one of: an email communication session, a Short Message Service (SMS) communication session, and a chat communication session, and wherein allowing the incoming communication session comprises unencrypting the incoming communication session based on a digital certificate in the incoming communication session.

22. The system of claim 18, wherein the incoming communication session is one of an email, a voicemail, and a videomail, wherein allowing the incoming communication session comprises one of: displaying a header of the email, playing a portion of the voicemail, playing a portion of the videomail, and wherein in order to see a body of the email, play the voicemail communication, or play the videomail communication, the second user has to provide a valid authentication credential and/or a second authentication code.
